(19) United States
(12) Patent Application Publication
(10) Pub. No.: US 2006/0289500 A1
(43) Pub. Date: Dec. 28, 2006

(54) Semiconductor memory card comprising semiconductor memory chip

(76) Inventors: Naohisa Okumura, Yokohama-shi (JP); Taku Nishiyama, Yokohama-shi (JP); Kiyokazu Okada, Yokkaichi-shi (JP); Makato Minaminaka, Suzuka-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/415,207

(22) Filed: May 2, 2006

(30) Foreign Application Priority Data
May 11, 2005 (JP) 2005-138719
May 17, 2005 (JP) 2005-144265

(51) Int. Cl. H05B 6/64

(52) U.S. Cl. 219/686

(57) ABSTRACT

A semiconductor memory card includes a circuit board and a cover case. The circuit board has a semiconductor memory chip on one surface and an electrode on the other surface. The cover case has a first storage section on one surface. The first storage section contains the semiconductor memory chip, and the circuit board is attached to the cover case by use of an adhesive material. A second storage section different from the first storage section is formed around the first storage section. The second storage section is located at a peripheral portion of the circuit board.

### CROSS-REFERENCE TO RELATED APPLICATIONS

This application is based upon and claims the benefit of priority from prior Japanese Patent Applications No. 2005-138719, filed May 11, 2005; and No. 2005-144265, filed May 17, 2005, the entire contents of both of which are incorporated herein by reference.

### BACKGROUND OF THE INVENTION

1. Field of the Invention

The present invention relates to a semiconductor memory card. More particularly, the invention relates to a semiconductor memory card comprising (i) a cover case, and (ii) a circuit board which is attached to one surface of the cover case and which has a semiconductor memory chip mounted thereon. Alternatively, the invention relates to a semiconductor memory card comprising (i) a cover case, and (ii) a semiconductor package which is attached to one surface of the cover case and which includes a memory device mounted on a circuit board.

2. Description of the Related Art

In recent years, an increasing number of small-sized electronic devices such as cellular phones is provided with a semiconductor memory card serving as a removable external storage device. Since the recent electronic devices are small in size and light in weight, the semiconductor memory card is also required to be small in size and light in weight, while simultaneously satisfying the requirement for a large storage capacity.

To satisfy these requirements, smaller and thinner semiconductor memory cards have been developed. A semiconductor memory card of this type comprises a circuit board attached to one surface of a cover case, and a semiconductor memory chip is mounted on the circuit board. However, a semiconductor memory card of this type has problems in that the card performance is not necessarily good and the productivity is poor. To be more specific, in the card assembling process, a cover case is attached using an adhesive material in film (sheet) or paste form. To ensure sufficient adhering strength, the area of the adhesive material to be coated or arranged has to be wide. When a cover case and a circuit board are attached to each other, an excessive adhesive material may ooze out and attach to the surface of the cover case or an external terminal on the circuit board. If the adhesive material is on the surface of the cover case, this not only makes the cover case visually undesirable but also causes a contact failure of the external terminals. For this reason, the productivity cannot be enhanced.

Jpn. Pat. Appln. KOKAI Publication No. 6-143884 discloses an IC card wherein a circuit board incorporating an electronic component is contained in upper and lower cases. This publication, however, aims to provide a tough and environment-resistant IC card by filling the interior of the cases (in which an electronic component and a circuit board are contained) by use of foaming resin. When the interior of the cases is completely filled with foaming resin, the invention of KOKAI Publication No. 6-143884 recovers an excessive filling resin at a recovery section so as to evacuate the air from inside the case. As can be seen from this, the invention of KOKAI Publication No. 6-143884 is not suitable for manufacturing very small and thin semiconductor memory cards.

A circuit board may have burrs caused when it is cut out from a plate material. Such burrs may be a problem when a thin semiconductor memory card is manufactured, especially when a very small and thin semiconductor memory card is manufactured.

In a very small and thin semiconductor memory card of another type, a semiconductor memory package incorporating a semiconductor memory device on a circuit board is attached to one surface of a cover case. This type of semiconductor memory card also has problems in that the card performance is not necessarily good and the productivity is poor. To be more specific, in the card assembling process, a cover case and a semiconductor package are attached to each other by use of an adhesive material in film or paste form. At the time of attachment, air may remain on the adhesive surface of the adhesive material. In this case, the adhesive material may ooze out of the joining surfaces of the case and semiconductor package in the amount corresponding to the volume of the air. The oozing adhesive material may attach to the surface of the cover case or an external terminal provided on the circuit board.

The assembling process of this type of semiconductor memory card includes heat treatment executed after the cover case and the semiconductor package are attached to each other. The heat treatment is intended to harden the adhesive material. When this heat treatment is executed, the air remaining on the adhesive surface will expand, resulting in deformation of the case or damage thereto.

As can be seen from the above, it is hard for the prior art to properly control the amount of amount of adhesive material supplied, in such a manner as to ensure sufficient adhesion strength.

### BRIEF SUMMARY OF THE INVENTION

According to a first aspect of the present invention, there is provided a semiconductor memory card comprising: a circuit board including a semiconductor memory chip on one surface thereof and an electrode on another surface thereof; and a cover case including a first storage section on one surface, the first storage section containing the semiconductor memory chip, the circuit board being attached to the cover case by use of an adhesive material, wherein a second storage section different from the first storage section is formed around the first storage section on the one surface of the cover case in such a manner the second storage section is located at a peripheral portion of the circuit board.

According to a second aspect of the present invention, there is provided a semiconductor memory card comprising: a semiconductor package device including a semiconductor memory device on one surface of a circuit board and an electrode on another surface of the circuit board; and a cover case including a storage section on one surface, the semiconductor package device being attached to the storage section by use of an adhesive material, wherein the cover case further includes an exhaust port leading to the outside of the case and configured to discharge air from inside the storage section when the cover case and the semiconductor package device are pasted.

### BRIEF DESCRIPTION OF THE SEVERAL VIEWS OF THE DRAWING

FIGS. 1A to 1D show an example of a semiconductor memory card according to a first embodiment of the present invention.

FIGS. 2A and 2B are sectional views of the semiconductor memory card of the first embodiment.

FIGS. 3A to 3C show an example of a cover case that can be used with the semiconductor memory card of the first embodiment.

FIGS. 4A and 4B show examples of circuit boards that can be used with the semiconductor memory card of the first embodiment.

FIGS. 5A and 5B show other examples of circuit boards that can be used with the semiconductor memory card of the first embodiment.

FIGS. 6A to 6C show another example of a cover case that can be used with the semiconductor memory card of the first embodiment.

FIGS. 7A to 7C show still another example of a cover case that can be used with the semiconductor memory card of the first embodiment.

FIGS. 8A and 8B show an example of a semiconductor memory card according to a second embodiment of the present invention.

FIGS. 9A and 9B show an example of a semiconductor package employed in the semiconductor memory card of the second embodiment.

FIGS. 10A to 10C show an example of a cover case adapted for use with the semiconductor memory card of the second embodiment.

FIGS. 11A to 11D are sectional views illustrating the steps in which the semiconductor memory card of the second embodiment is manufactured.

FIG. 12 is a plan view showing another example of a cover case adapted for use with the semiconductor memory card of the second embodiment.

FIG. 13 is a plan view showing still another example of a cover case adapted for use with the semiconductor memory card of the second embodiment.

FIG. 14 is a plan view showing a further example of a cover case adapted for use with the semiconductor memory card of the second embodiment.

FIG. 15 is a plan view showing a still further example of a cover case adapted for use with the semiconductor memory card of the second embodiment.

FIG. 16 is a plan view showing another example of a cover case adapted for use with the semiconductor memory card of the second embodiment.

FIG. 17 is a sectional view showing another example of a cover case adapted for use with the semiconductor memory card of the second embodiment.

### DETAILED DESCRIPTION OF THE INVENTION

Embodiments of the present invention will now be described with reference to the accompanying drawing figures. It should be noted that the drawing figures are schematic and do not necessarily reflect actual dimensions of structural elements. It should be also noted that the drawing figures include portions in which the dimensional relationships or proportions may vary.

### First Embodiment

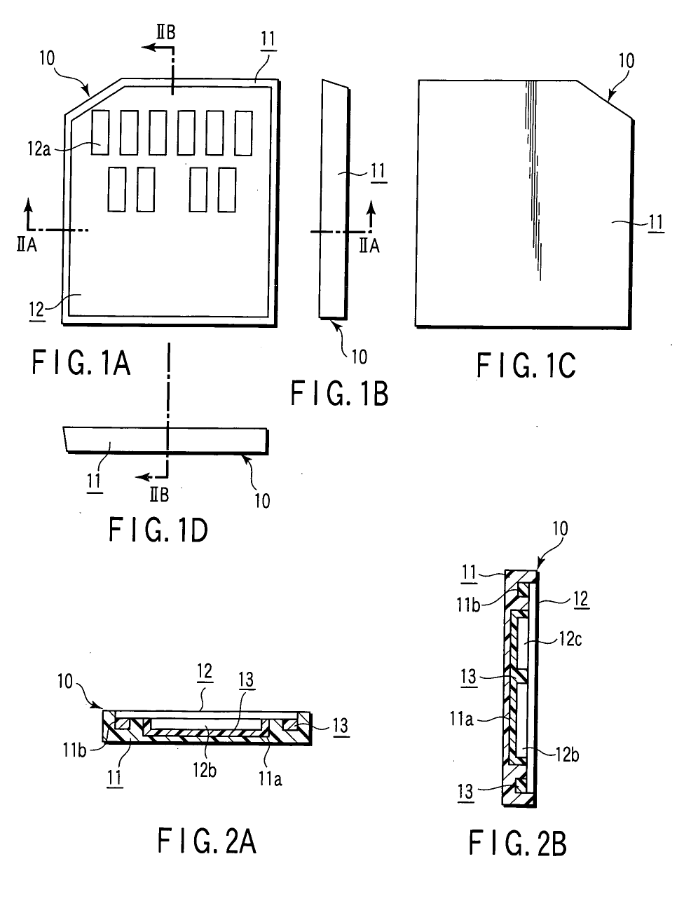

FIGS. 1A to 1D show a fundamental structure (especially the outward appearance) of a semiconductor memory card according to a first embodiment of the present invention.

FIG. 1 is a plan view showing one surface of the semiconductor memory card (i.e., the surface on which external terminals are provided). FIG. 1B is a side view showing one side of the card. FIG. 1C is a plan view showing another surface of the card (i.e., the surface closer to the case). FIG. 1D is a side view showing another side of the card.

The semiconductor memory card 10 comprises a cover case 11 and a circuit board 12. The circuit board 12 has an exposed surface (i.e., a surface not covered with the cover case 11), and a plurality of external electrodes 12a are provided in two rows on the exposed surface of the circuit board 12.

FIGS. 2A and 2B show sectional structures of the semiconductor memory card 10 depicted in FIGS. 1A to 1D. FIG. 2A is a sectional view taken along line IIA-IIA in FIG. 1A, and FIG. 2B is a sectional view taken along line IIB-IIB in FIG. 1A.

The semiconductor memory card 10 is made by attaching the circuit board 12 to one surface of the cover case 11 by use of an adhesive material 13. The circuit board 12 has a semiconductor memory chip 12b and another structural component 12c (such as a semiconductor element or an electronic device), which are received in a storage section (a first storage section) provided on one side of the cover case 11.

The cover case 11 and circuit board 12 of the above semiconductor memory 10 will be described in more detail.

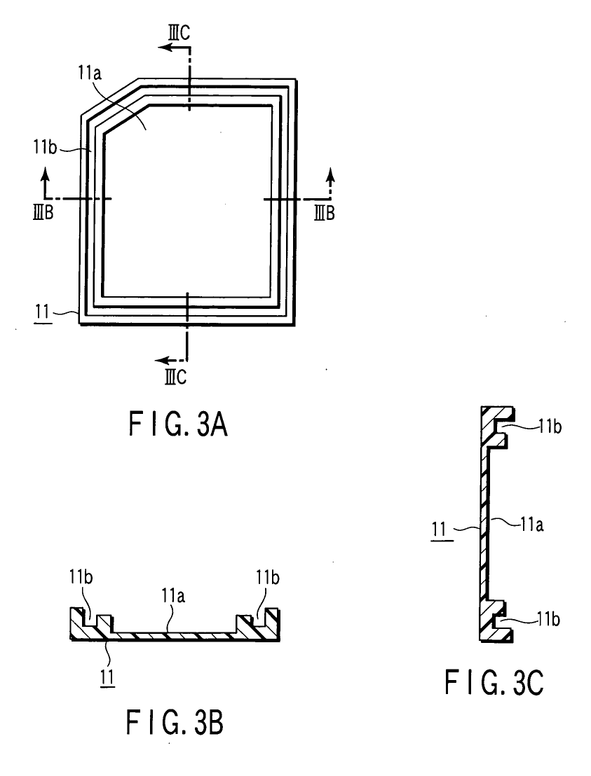

FIGS. 3A to 3C shows the cover case 11. FIG. 3A is a plan view showing one surface of the cover case 11, FIG. 3B is a sectional view taken along line IIIB-IIIB in FIG. 3A, and FIG. 3C is a sectional view taken along line IIIC-IIIC.

The cover case 11 has a first storage section 11a in one surface thereof. The first storage section is substantially rectangular and adapted to store the semiconductor memory chip 12b and another structural component 12c which are mounted on the circuit board 12. An adhesive material recovery section 11b, which serves as a second storage section, is formed around the first storage section 11a in such a manner as to surround the first storage section 11a. In the case of the first embodiment, the adhesive material recovery section 11b is formed at the outer periphery of the circuit board 12.

The cover case 11 has a thickness of 1.4 mm±100 μm.

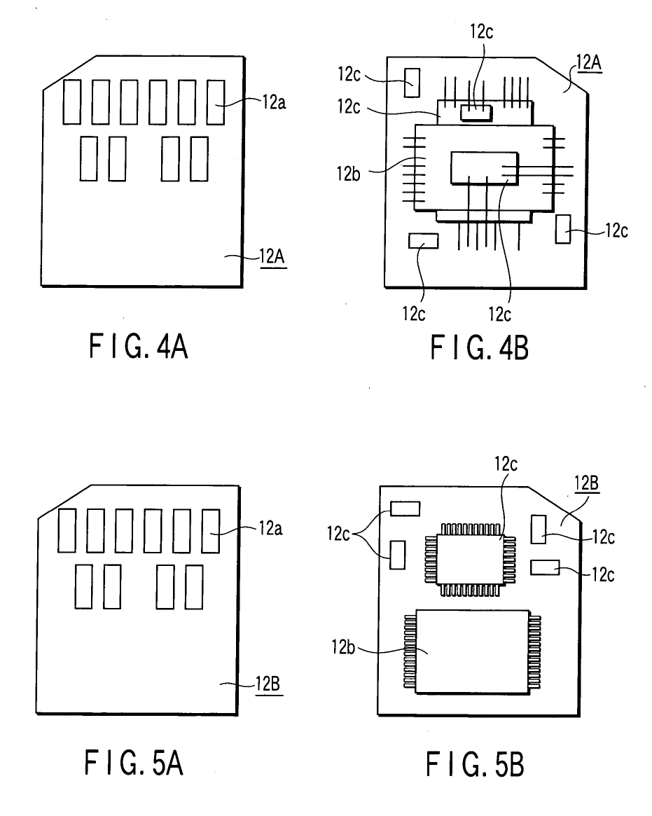

FIGS. 4A and 4B show a configuration example of the circuit board 12. FIG. 4B is a plan view showing the first surface of the circuit board 12A, and FIG. 4A is a plan view showing the second surface of the circuit board 12A.

A plurality of external terminals (electrodes) 12a are arranged in two rows on the second surface of the circuit board 12A, as shown in FIG. 4A. On the first surface of the circuit board 12a, the semiconductor memory chip 12b and another component 12c (such as a semiconductor element or a passive element) are arranged on the first surface of the circuit board 12A, as shown in FIG. 4B. In the case of the first embodiment, the semiconductor chip 12b and structural component 12c overlap each other.

FIGS. 5A and 5B show another example of the circuit board 12. FIG. 5A is a plan view showing the second surface of the circuit substrate 12B, and FIG. 5B is a plan view showing the first surface of the circuit substrate 12B.

A plurality of external terminals (electrodes) 12a are arranged in two rows on the second surface of the circuit board 12B, as shown in FIG. 5. On the first surface of the circuit board 12B, the semiconductor memory chip 12b and another component 12c (such as a semiconductor element or a passive element) are arranged, as shown in FIG. 5B.

A method for manufacturing the above semiconductor memory card 10 will be described briefly. In the assembling process of the semiconductor memory card, the circuit board 12 is attached to one surface of the cover case 11 by using the adhesive material 13 which is either in the film form or in the paste form. To obtain the maximal adhesion strength, the area on which the adhesive material in the paste form is coated or the adhesive material in the film form is provided is made as wide as possible.

When the cover case 11 and the circuit board 12 are attached to each other, an excessive adhesive material 13 flows out of the first storage section 11a. The excessive adhesive material 13 flows into the adhesive material recovery section 11b and does not flow out of the region between the cover case 11 and the circuit board 12. With this structure, sufficient adhesion strength is ensured, and yet the adhesive material 13 does not attach to the surface of the cover case 11 or the external terminals 12a of the circuit board 12. Since the excessive adhesive material 13 does not attach to the surface of the cover case 11, the appearance of the semiconductor memory card 10 is not degraded. In addition, since the excessive adhesive material 13 does not attach to the external terminals 12a of the circuit board 12a, it is possible to prevent performance degradation, such as a contact failure, thus contributing to improvement of productivity.

Where the above structure is adopted, burrs which may be produced on the peripheral portions of the circuit board 12 are received in the adhesive material recovery section 11b. Such burrs do not become an obstacle when the cover case 11 and the circuit board 12 are pasted. As a result, the semiconductor memory card 10 can be as flat as possible.

In the manner described above, the very small and thin semiconductor memory card 10, which is substantially as thin as the cover case 11 (which has a thickness of 1.4 mm±100 μm), can be manufactured with high efficiency.

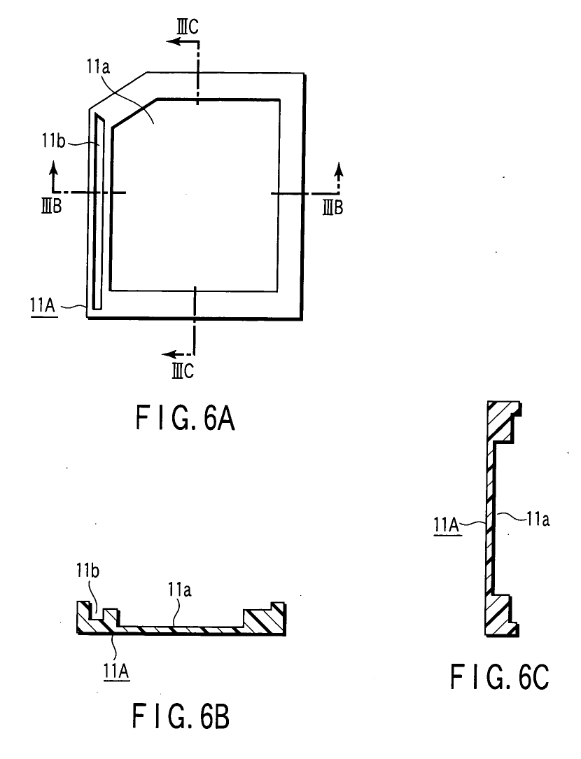

In the first embodiment, the adhesive material recovery section 11b (second storage section) surrounds the first storage section 11a. However, this structure does not restrict the present invention. That is, the cover case 11A shown in FIGS. 6A to 6C may be used in place of the cover case 11A described above. In the alternative cover case 11A shown in FIGS. 6A to 6C, the first storage section 11a is substantially rectangular, and an adhesive material recovery section 11b is provided on at least one side of the first storage section 11a. In this case, the adhesive material recovery section 11b is at least one in number.

Moreover, the adhesive material recovery section 11b provided at one side of the first storage section 11a need not be a peripheral portion of the circuit board 12. The adhesive material recovery section 11b at a peripheral portion of the first storage section 11a may be between the surrounding portion of the circuit board 12 and the outer peripheral portion of the first storage section 11a.

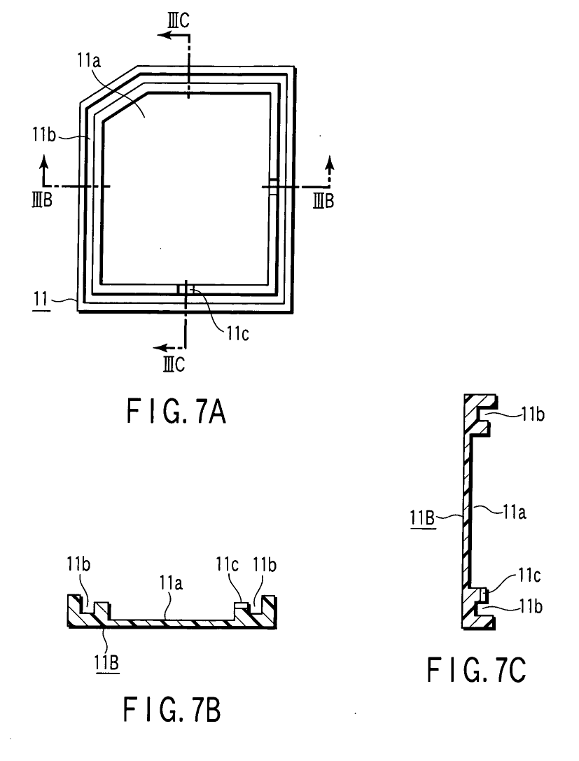

As shown in FIGS. 7A to 7C, the cover case 11B may be made of a substantially rectangular first storage section 11a and an adhesive material recovery section 11b, between which one or more air exhaust ports 11c (through holes or recesses) are provided.

### Second Embodiment

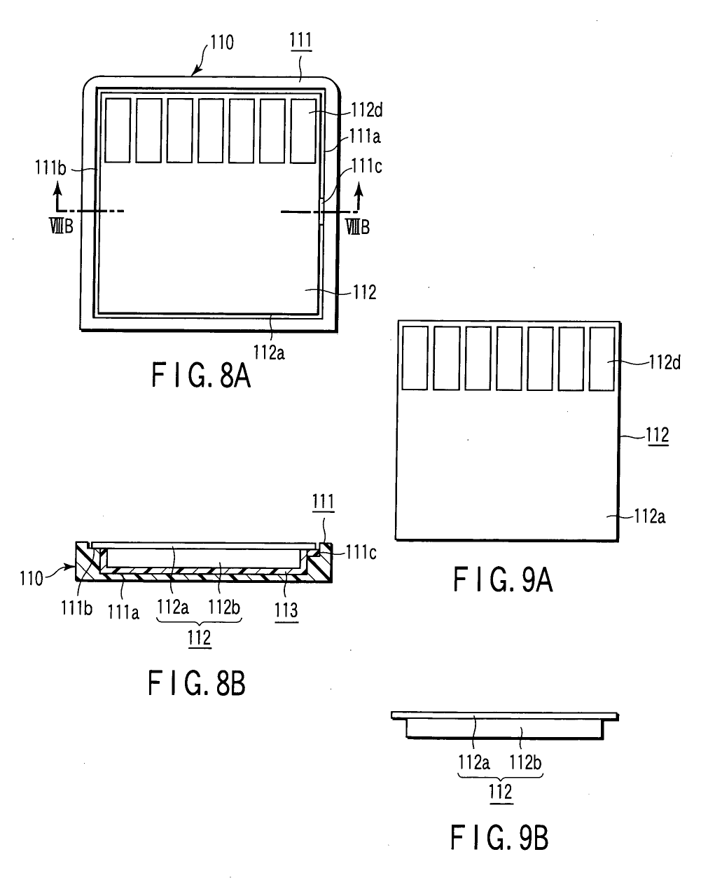

FIGS. 8A and 8B show a fundamental structure of a semiconductor memory card according to a second embodiment of the present invention. FIG. 8A is a plan view showing one surface of the semiconductor memory card (i.e., the surface on which external terminals are provided). FIG. 8B is a side view taken along line VIIIB-VIIIB in FIG. 8A.

The semiconductor memory card 110 is mainly made up of a cover case 111 and a semiconductor package 112. As shown in FIGS. 9A and 9B, the semiconductor package 112 includes a circuit board 112a, and at least a semiconductor memory device mounted on one surface of the circuit board 112a. The semiconductor memory device is sealed in resin 112b. The other surface of the circuit board 112a is not covered with the cover case 111 and is thus exposed to the outside. The other surface of the circuit board 112a serves as the second surface of the semiconductor package 112, and a plurality of external terminals (electrodes) 112d are arranged on the second surface of the semiconductor package 112. The semiconductor package 112 may be assembled by mounting a semiconductor memory package on one surface of the circuit board by soldering.

It should be noted that FIG. 9A is a plan view of the semiconductor package 112, and FIG. 9B is a side view thereof.

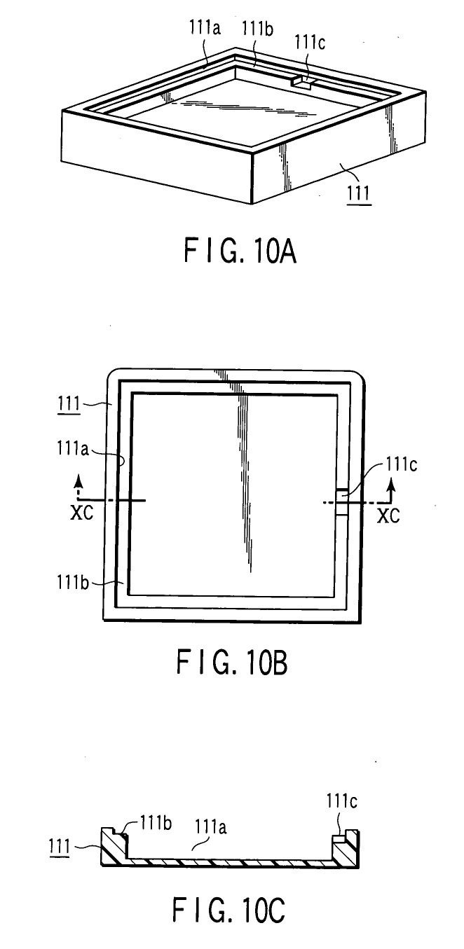

The cover case 111 has a storage section 111a to which the semiconductor package 112 is attached by use of the adhesive material 113. As shown in FIGS. 10A to 10C, the mount portion 111b of the storage section 111a, which the peripheral portions of the circuit board 112a engage with, has at least one air exhaust port (notch) 111c. In the case of the second embodiment, the storage section 111a is substantially rectangular, and one air exhaust port 111c is formed in the mount portion 111b corresponding to one side of the rectangular storage section 111a. When the cover case 111 and the semiconductor package 112 are pasted together in the assembling process, the air exhaust port 111c permits the air remaining in the storage section 111a to be exhausted to the outside of the cover case 111. In other words, the air exhaust port 111c communicates directly with the outside of the cover case 111.

FIG. 10A is a perspective view of the cover case 111, and FIG. 10B is a plan view thereof, and FIG. 10C is a sectional view taken along line XC-XC in FIG. 10B.

The cover case 111, which has the structure described above, is formed of a plastic material. The cover case 111 has a thickness of 1.4 mm±100 μm at the thickest portion. The cover case 111 is thinnest at the bottom of the storage section 111a, and the thickness of this portion is approximately 200 μm.

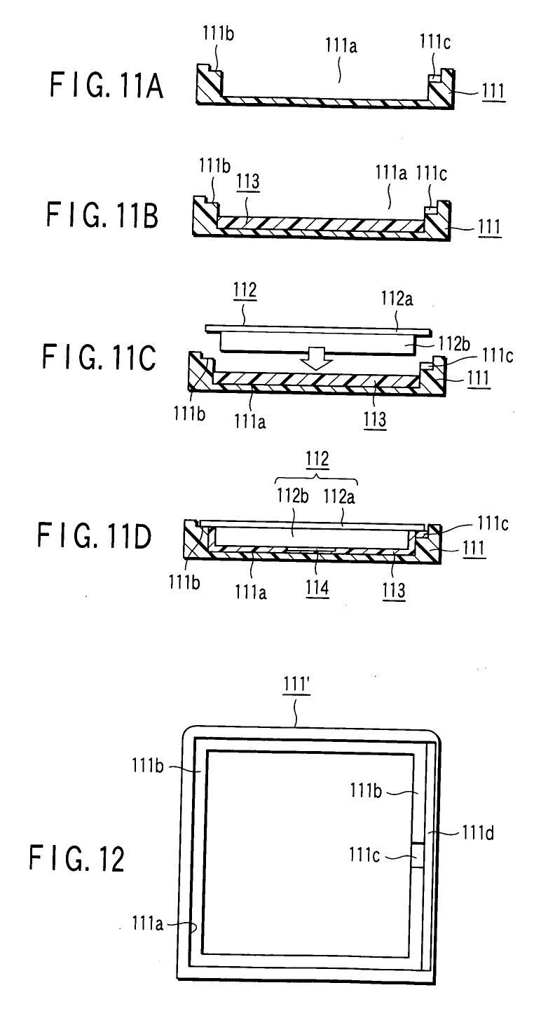

FIGS. 11A to 11D illustrate the steps in which the semiconductor memory card 110 having the above structure is manufactured. The assembling process of the semiconductor memory card 110 begins with the step of coating the bottom of the storage section 111a of the cover case 111 with the adhesive material 113 in the paste form (or in the sheet form), as shown in FIGS. 11A and 11B. The adhesive material 113 may be coated entirely over the storage section 111a by potting. Alternatively, it may be applied to selected portions (which are dot or stripe patterns) of the storage section 111a by use of a nozzle. To permit the air to smoothly flow out without reference to the pasting direction, the adhesive material 113 should be preferably coated discontinuously. In particular, the adhesive material 113 should not be applied to the portions that are in the vicinity of the air exhaust port 111c.

Then, the cover case and the semiconductor package 112 are pasted to each other, as shown in FIG. 11C. When they are pasted, air 114 may enter the interface between them, as shown in FIG. 11D. As the pasting operation makes progress, the air 114 is efficiently discharged from the storage section 111a to the outside of the semiconductor memory card 110 by way of the air exhaust port 111c. Hence, the air 114 is prevented from remaining inside the storage section 111a, as shown in FIG. 8B.

If the air 114 remains in the interface, the adhesive material 113 may flow out of the storage section 111a and attach to the surface of the cover case 111 or the external terminals 112d of the semiconductor package 112. Since the adhesive material 113 does not attach to the surface of the cover case, the outward appearance of the cover case 111 is not degraded. In addition, since the adhesive material 113 does not attach to the external terminals 112d, a contact failure or another undesirable phenomenon is not caused, thus contributing to improvement of the productivity.

In the assembling process of the semiconductor memory card, heat treatment is executed after the cover case 111 and the semiconductor package 112 are pasted together so as to harden the adhesive material 113. If air 114 exists in the interface when the heat treatment is executed, the air will expand and the case (card) 111 may be deformed or damaged, especially in the bottom of the storage section 111a. This problem does not occur in the case of the present invention.

In the assembling process described above, the adhesive material 113 may be coated entirely over the semiconductor package 112 by potting. Alternatively, it may be applied to selected portions of the semiconductor package 112 by use of a nozzle.

As described above, the air remaining in the storage section 111a can be guided to the outside of the semiconductor memory card 110 through the air exhaust port 111c. Thanks to this feature, the semiconductor memory card 110 is as thin as the cover case (which has a thickness of 1.4 mm±100 μm). It is therefore possible to efficiently manufacture semiconductor memory cards which are very small and thin and which do not have problems in outward appearance.

FIG. 12 shows a modification of a cover case 111′. In this modification, an adhesive material recovery section 111d, which is for recovering the adhesive material overflowing from a storage section 111a, is provided for at least part of the regions surrounding the storage section 111a. An air discharge hole 111c communicating with the outside is connected to the recovery section 111d.

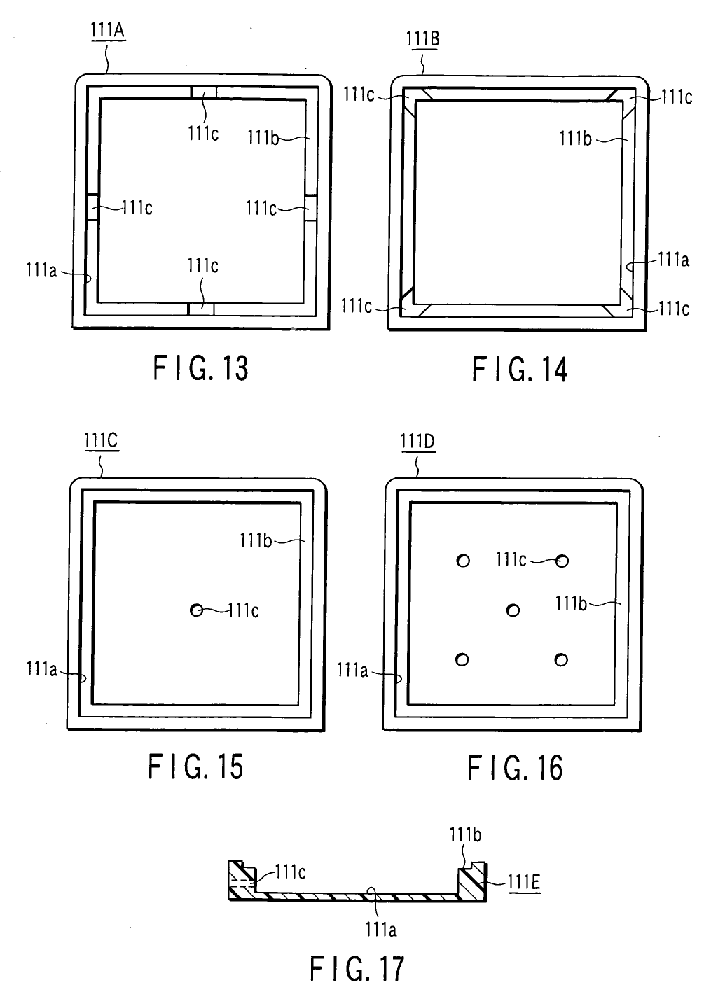

In the embodiment described above, the cover case 111 has one air exhaust port (notch) 111c that is provided for the mount section 111b corresponding to one of the sides of the substantially rectangular storage section 111a. However, this does not restrict the present invention. As shown in FIG. 13, the cover case 111A may have four air exhaust ports (notches) 111c that are provided for the mount sections 111b corresponding to the four sides of the substantially rectangular storage section 111a.

As shown in FIG. 14, moreover, the cover case 111B may be provided with four air exhaust ports (notches) that are provided in the mount sections 111b corresponding to the four corners of the substantially rectangular storage section 111a.

As shown in FIG. 15, a cover case 111C may have a single air discharge hole (through hole) 11c that is formed in the center of the bottom of the substantially rectangular storage section 111a.

As shown in FIG. 16, a cover case 111D may have a plurality of air discharge holes (through holes) 111c (five air discharge holes in the case shown in FIG. 16) that are formed in the bottom of a substantially rectangular storage section 111.

As shown in FIG. 17, a cover case 111E may have one or more air discharge holes (through holes) that are formed in one side wall of a substantially rectangular storage section 111a.

As described above, the air exhaust ports (holes) are not restricted in terms of their positions, numbers, and shapes. They can be properly provided in consideration of how the air flows relative to the direction of adhesion.

Likewise, the amount of adhesive material 113 applied, the positions to which the adhesive material 113 is applied, and the shapes the applied adhesive material 113 should have, can be arbitrarily determined in accordance with how the air flows relative to the direction of adhesion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor memory card comprising:
a circuit board including a semiconductor memory chip on one surface thereof and an electrode on another surface thereof; and
a cover case including a first storage section on one surface, the first storage section containing the semiconductor memory chip, the circuit board being attached to the cover case by use of an adhesive material,
wherein a second storage section different from the first storage section is formed around the first storage section on the one surface of the cover case such that the second storage section is located at a peripheral portion of the circuit board.

2. The semiconductor memory card according to claim 1, wherein the second storage section stores the adhesive material.

3. The semiconductor memory card according to claim 1, wherein the adhesive material is in paste form.

4. The semiconductor memory card according to claim 3, wherein the adhesive material is applied entirely to surfaces of the first storage section.

5. The semiconductor memory card according to claim 1, wherein the adhesive material is in sheet form.

6. The semiconductor memory card according to claim 5, wherein the adhesive material is applied entirely to surfaces of the first storage section.

7. The semiconductor memory card according to claim 1, wherein the second storage section receives burrs caused on the peripheral portion of the circuit board.

8. The semiconductor memory card according to claim 1, wherein the cover case has a thickness of 0.1.4 mm±100 μm.

9. The semiconductor memory card according to claim 1, wherein the circuit board further includes a semiconductor component and an electronic component on the one surface thereof.

10. The semiconductor memory card according to claim 1, wherein the cover case has an exhaust port communicating with an outside region.

11. A semiconductor memory card comprising:
a semiconductor package device including a semiconductor memory device on one surface of a circuit board and an electrode on another surface of the circuit board; and
a cover case including a storage section on one surface, the semiconductor package device being attached to the storage section by use of an adhesive material,
wherein the cover case further includes an exhaust port communicating with an outside region and configured to discharge air from inside the storage section when the cover case and the semiconductor package device are pasted together.

12. The semiconductor memory card according to claim 11, wherein the exhaust port is an at least one notch formed in a mount section on which a peripheral portion of the circuit board is mounted.

13. The semiconductor memory card according to claim 11, wherein the exhaust port is an at least one through hole formed in a side wall or bottom of the storage section.

14. The semiconductor memory card according to claim 11, wherein the adhesive material is in paste form.

15. The semiconductor memory card according to claim 14, wherein the adhesive material is applied entirely or partially to surfaces of the semiconductor package or storage section.

16. The semiconductor memory card according to claim 11, wherein the adhesive material is in sheet form.

17. The semiconductor memory card according to claim 16, wherein the adhesive material is applied entirely or partially to surfaces of the semiconductor package or storage section.

18. The semiconductor memory card according to claim 11, wherein the storage section of the cover case has a peripheral portion where a recovery section that stores the adhesive material overflowing from the storage section is formed.

19. The semiconductor memory card according to claim 11, wherein the cover case has a thickness of 1.4 mm±100 μm, and the storage section has a bottom of 200 μm.
